(19) United States
(12) Patent Application Publication
(10) Pub. No.: US 2005/0086614 A1
(43) Pub. Date: Apr. 21, 2005

(54) MULTI-MODE PORTABLE ELECTRONIC APPARATUS AND METHOD FOR THE MULTI-MODE PORTABLE ELECTRONIC APPARATUS TO OUTPUT AV SIGNALS

(76) Inventors: Chih-Chuan Cheng, Taipei City (TW); Wen-Sung Tsai, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/709,445

(22) Filed: May 6, 2004

(30) Foreign Application Priority Data
Oct. 21, 2003 (TW) 092129186

(51) Int. Cl. G06F 17/00; G11B 27/00

(52) U.S. Cl. 715/864; 710/8

(57) ABSTRACT

A multi-mode portable electronic apparatus includes an AV signal display device for displaying AV signals, a processor, an AV signal generator for generating the AV signals, a receiving port for receiving external AV signals, a selecting module for selecting whether to output the AV signals generated by the AV signal generator or the external AV signals received via the receiving port, and a memory for storing an OS. When the OS is not started and the AV signals generated by the AV signal generator are selected to be output, start the OS first so that the AV signals generated by the AV signal generator can be output. If the external AV signals received via the receiving port are selected to be output, then the external AV signals can be processed by the processor and output to the AV signal display device without the OS.

### BACKGROUND OF INVENTION

1. Field of the Invention

The invention relates to a portable electronic apparatus, and more particularly, to a multi-mode portable electronic apparatus capable of switching sources of audiovisual (AV) signals.

2. Description of the Prior Art

In the modern information-oriented society, portable electronic apparatuses such as notebook computers, personal digital assistants (PDA), mobile phones, and tablet PC are widely used. Being small in size, light in weight, and convenient to carry, portable electronic apparatuses are no longer limited to a specific place. Take notebook computers for example, they are going to replace conventional desktop computers because of their portability and admirable performance in word processing and multimedia processing. Furthermore, with the substantial boom of the processing speed and the development of multimedia, the application of computers is not limited to word processing. It becomes more and more common to play and access images and voices via the powerful processing ability of computers so as to provide convenience to both life and work.

As technology progressed, notebook computers became capable of outputting high-quality audio and video signals. With reference to FIG. 1, there is shown a block diagram of an audiovisual (AV) signal processing framework of a conventional notebook computer 10. The notebook computer 10 includes an audiovisual (AV) signal processing unit 12, a display panel 18, and a speaker 20. Furthermore, the display panel 18 has a driving circuit 14, and the speaker 20 has a sound amplifier 16. The AV signal processing unit 12 serves to generate audio and video signals. The AV signal processing unit 12 further has a video signal output terminal 22 and an audio signal output terminal 24, which are respectively connected in an electrical manner to the driving circuit 14 and the sound amplifier 16 for transmitting the audio and video signals generated by the AV signal processing unit 12 to the driving circuit 14 and the sound amplifier 16. The video signals output by the video signal output terminal 22 are transmitted to the driving circuit 14, which then outputs control signals to drive the display panel 18 and thereby displaying the video signals. Similarly, the audio signals output by the audio signal output terminal 24 are transmitted to the sound amplifier 16, which then amplifies the audio signals for the speaker 20 to play. The display panel 18 is electrically connected to the video signal output terminal 22 of the AV signal processing unit 12. The display panel 18 uses the driving circuit 14 to receive the video signals output by the video signal output terminal 22, and then the image is displayed according to the control signal generated by the driving circuit 14. Moreover, the speaker 20 is electrically connected to the audio signal output terminal 24 of the AV signal processing unit 12. The sound amplifier 16 of the speaker 20 receives and amplifies the audio signals output by the audio signal output terminal 24 and then plays them.

The notebook computer 10 uses the AV signal processing unit 12 as its main device to process and output AV signals. Typically, the AV signal processing unit is a video card combined with a sound card or the equivalent element thereof, such as a video chip and a sound chip installed on the motherboard. Through the AV signal processing unit 12, the notebook computer 10 can output audio and video signals using the display panel 18 and the speaker 20. Accordingly, the users can receive those audio and video signals. However, the operating system of the conventional notebook computer has to be in an operational status, i.e. the notebook computer has to boot up first, and then the AV signal processing unit 12 can proceed with AV signals related processing under the synergistic processing and instruction of the operating system. Additionally, the functions of AV signal output related devices, such as the driving circuit 14, the sound amplifier 16, the display panel 18, and the speaker 20, can only operate when the operating system (OS) is operating. Thus, if the user wants to enjoy only AV entertainment, but not execute the applied software, he still has to boot up the computer, which is not only time-consuming but also power-consuming. Moreover, multiple conversion, compression, and decompression are required to process external AV signals, and consequently the played AV signals may not correspond with the reality of the external AV signals before processing.

### SUMMARY OF INVENTION

It is therefore a primary objective of the claimed invention to provide a multi-mode portable electronic apparatus capable of switching the sources of AV signals so that the electronic apparatus can play the AV signals without an OS, in order to solve the problem that external AV signals are conventionally accessed only when the OS is turned on.

Briefly, the present invention provides a method for outputting audio/visual (AV) signals of a portable electronic apparatus, which includes (a) selecting the source of the AV signals to be output by the portable electronic apparatus, and (b) outputting the AV signals generated by the portable electronic apparatus or the AV signals externally input to the portable electronic apparatus according to the selection made in step (a).

The present invention further provides a multi-mode portable electronic apparatus. The multi-mode portable electronic apparatus includes an AV signal display device for displaying AV signals, a processor electrically connected to the AV signal display device, an AV signal generator electrically connected to the processor for generating the AV signals, a receiving port electrically connected to the processor for receiving external AV signals, and a selecting module electrically connected to the processor for selecting whether the portable electronic apparatus outputs the AV signals generated by the AV signal generator or the external AV signals received via the receiving port.

The present invention further provides another multi-mode portable electronic apparatus, which includes an AV signal display device for displaying AV signals; a processor electrically connected to the AV signal display device for executing a program code; an AV signal generator electrically connected to the processor for generating the AV signals; a receiving port electrically connected to the processor for receiving external AV signals; and a non-volatile memory storing the program code for selecting whether the portable electronic apparatus outputs the AV signals generated by the AV signal generator or the external AV signals received via the receiving port.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram showing the audiovisual (AV) signal processing framework of a conventional notebook computer; and

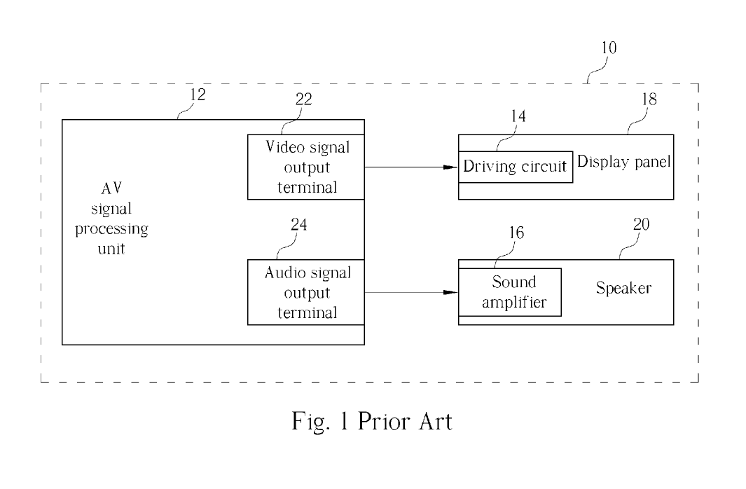

FIG. 2 is a block diagram showing the audiovisual (AV) signal processing framework of the multi-mode portable electronic apparatus according to the present invention.

### DETAILED DESCRIPTION

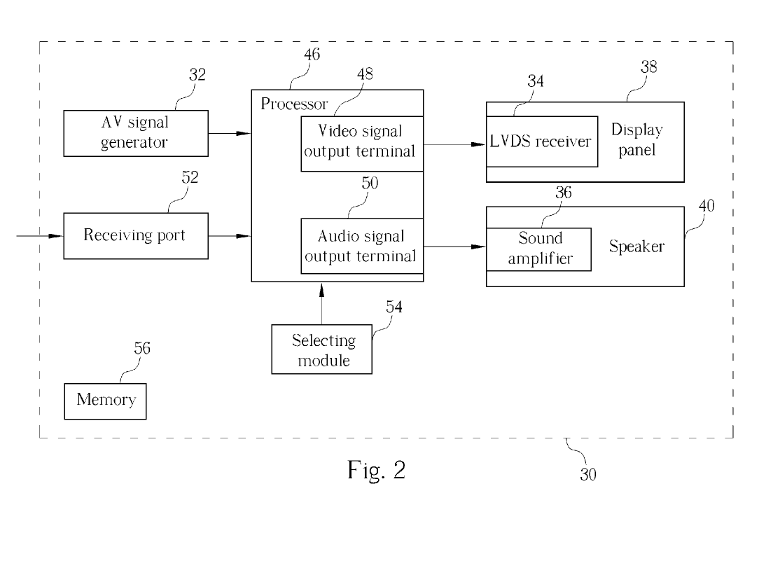

With reference to FIG. 2, there is shown a block diagram of the audiovisual (AV) signal processing framework of a multi-mode portable electronic apparatus 30 according to the present invention. The portable electronic apparatus 30 can be a notebook, a personal data assistant (PDA), a mobile phone, or a tablet PC, all of which include a display panel 38, a speaker 40, a processor 46, a audiovisual signal generator 32, a receiving port 52, a selecting module 54, and a memory 56. The display panel 38 has a low-voltage differential signal receiver 34 for receiving video signals and generating control signals to have the display panel 38 display images. The speaker 40 has a sound amplifier 36 for receiving and amplifying audio signals to make the speaker 40 play. The processor 46 has a video signal output terminal 48 and an audio signal output terminal 50 respectively connected in an electrical fashion to the low-voltage differential signal receiver 34 and the sound amplifier 36 of the speaker 40. The memory 56 is used for storing an OS. In the present embodiment, with the case of the portable electronic apparatus 30 being a notebook computer, when the user is going to play internal AV signals, he can send a selecting signal to the selecting module 54 first. After receiving the selecting signal of playing internal AV signals, the selecting module 54 transmits a command for playing internal AV signals to the processor 46 and activates the OS stored in the memory 56 so as to activate the circuits and applied programs related to accessing and playing internal AV signals. The audiovisual signal generator 32 outputs the AV signals generated by itself to the processor 46. The processor 46 processes the AV signals from the audiovisual signal generator 32 according to the command made by the selecting module 54 and outputs them respectively to the low-voltage differential signal receiver 34 of the display panel 38 via the video signal output terminal 48 and the sound amplifier 36 of the speaker 40 via the audio signal output terminal 50. Therefore, the AV signals are displayed and played respectively by the display panel 38 and the speaker 40. Moreover, the display panel 38 can be a thin film transistor liquid crystal displayer (TFT LCD).

In the case of playing external AV signals such as television signals, a selecting signal for playing external AV signals is sent to the selecting module 54. In addition, an external TV capture module converts the TV signals into composite signals and outputs them with audio signals to the receiving port 52. Then, the receiving port 52 transmits the external AV signals to the processor 46. After receiving selecting signals for playing external AV signals, the selecting module 54 transmits a command for playing external AV signals to the processor 46. The processor 46 decodes the composite signals into RGB signals according to the command made by the selecting module 54 and then outputs them to the low-voltage differential signal receiver 34 of the display panel 38 via the video signal output terminal 48. Consequently, the display panel 38 can display the external AV signals. Simultaneously, the processor 46 also outputs the audio signals from the receiving port 52 to the sound amplifier 36 of the speaker 40 via the audio signal output terminal 50 for the speaker 40 to play. In this case, except for the receiving port 52, the processor 46, the display panel 38, and the speaker 40, neither the devices in the notebook 10 nor the OS are required to be activated.

As mentioned above, when playing external AV signals by using the multi-mode portable electronic apparatus of the present invention, devices besides the receiving port, the processor, the selecting module, the display panel, and the speaker, are not required to be turned on, meaning that it is not necessary to activate the OS nor to provide additional power to those devices that do not have to be turned on. Therefore, the power can be substantially saved. For the above-mentioned purpose, a two-stage power switch can be applied to the electronic apparatus of the present invention. The first stage of the two-stage power switch turns on the receiving port, the processor, the display panel, and the speaker only; and the second stage turns on the whole system including the OS. Alternatively, the first stage turning-on can be defined as manual turning-on, and the second stage can be an automatic turning-on where the system automatically turns on the whole system to be at the second stage when the selecting module selects to play internal AV signals or execute other applications. Furthermore, the selecting module can be a program code of a basic input-output system (BIOS) stored in a non-volatile memory.

The present invention installs a selecting module and related circuits into a portable electronic apparatus, such as a notebook computer, a PDA, a mobile phone, or a tablet PC, having devices for playing AV signals so as to play AV signals without turning on the OS. Therefore, the power consumption can be substantially reduced in the present invention.

Those skilled in the art will readily observe that numerous modifications and alterations of the apparatus may be made while retaining the teachings of the invention. Accordingly, the above disclosure should be construed as limited only by the metes and bounds of the appended claims.

1. A method for a portable electronic apparatus to output audiovisual (AV) signals comprising:
(a) selecting the source of the AV signals to be output by the portable electronic apparatus; and
(b) outputting the AV signals generated by the portable electronic apparatus or the AV signals externally input to the portable electronic apparatus according to the selection made in step (a).

2. The method of claim 1 further comprising turning on the portable electronic apparatus.

3. The method of claim 1 further comprising turning on an operating system (OS) in the case the portable electronic apparatus selects to output the AV signals generated by itself in step (a).

4. A multi-mode portable electronic apparatus comprising:
an AV signal display device for displaying AV signals;
a processor electrically connected to the AV signal display device;
an AV signal generator electrically connected to the processor for generating the AV signals;
a receiving port electrically connected to the processor for receiving external AV signals; and
a selecting module electrically connected to the processor for selecting whether the portable electronic apparatus outputs the AV signals generated by the AV signal generator or the external AV signals received via the receiving port.

5. The electronic apparatus of claim 4 further comprising a memory for storing an operating system (OS).

6. The electronic apparatus of claim 4 wherein the AV signals include video signals, and the AV signal display device is a thin film transistor liquid crystal displayer (TFT LCD).

7. The electronic apparatus of claim 6 wherein the TFT LCD comprises a low-voltage differential signal (LVDS) receiver for receiving video signals in the AV signals received by the TFT LCD.

8. The electronic apparatus of claim 4 wherein the AV signals include audio signals, and the AV signal display device is a speaker.

9. The electronic apparatus of claim 8 wherein the speaker comprises a sound amplifier for amplifying audio signals in the AV signals received by the speaker.

10. The electronic apparatus of claim 8 being a notebook computer, a personal digital assistant (PDA), a mobile phone, or a tablet PC.

11. A multi-mode portable electronic apparatus comprising:
an AV signal display device for displaying AV signals;
a processor electrically connected to the AV signal display device for executing a program code;
an AV signal generator electrically connected to the processor for generating the AV signals;
a receiving port electrically connected to the processor for receiving external AV signals; and
a non-volatile memory storing the program code for selecting whether the portable electronic apparatus outputs the AV signals generated by the AV signal generator or the external AV signals received via the receiving port.

12. The electronic apparatus of claim 11 further comprising a memory for storing an OS.

13. The electronic apparatus of claim 11 wherein the AV signals include video signals, and the AV signal display device is a TFT LCD.

14. The electronic apparatus of claim 13 wherein the TFT LCD comprises an LVDS receiver for receiving video signals in the AV signals received by the TFT LCD.

15. The electronic apparatus of claim 11 wherein the AV signals include audio signals, and the AV signal display device is a speaker.

16. The electronic apparatus of claim 15 wherein the speaker comprises a sound amplifier for amplifying audio signals in the AV signals received by the speaker.

17. The electronic apparatus of claim 11 being a notebook computer, a PDA, a mobile phone, or a tablet PC.

18. The electronic apparatus of claim 11 wherein the program code is stored in a basic input-output system (BIOS) of the non-volatile memory.
